(19) United States
(12) Patent Application Publication
(10) Pub. No.: US 2018/0071935 A1
(43) Pub. Date: Mar. 15, 2018

(54) DEVICE FOR CUTTING A SHEET OR LAYER OF MATERIAL

(71) Applicant: PANOTEC SRL, Cimadolmo (IT)

(72) Inventor: Giuseppe CAPOIA, Cimadolmo (IT)

(21) Appl. No.: 15/558,214

(22) PCT Filed: Mar. 28, 2016
(86) PCT No.: PCT/IB2016/051747

§ 371 Date: Sep. 14, 2017

(30) Foreign Application Priority Data
Mar. 27, 2015 (IT) TV2015A000049

(51) Int. Cl. B26D 1/15; B26D 1/20; B26D 7/20; B26D 7/08

(52) U.S. Cl. CPC B26D 1/151; B26D 7/086; B26D 7/20; B26D 1/205

(57) ABSTRACT

A device is described for cutting a sheet or layer of material (C) advancing on a working plane (32). A blade (30) cuts the material moved on the working plane,

To avoid wear or damages to the working plane (32) the blade (30) comprises a cutting edge (38) which is suspended within a cavity (34) formed in the working plane, so that the cutting edge can come out from the material in correspondence of the cavity.

The invention relates in general to a device for cutting a sheet or layer of material, e.g. cardboard here chosen as favorite example. Other materials are possible, such as e.g. plastic or leather.

To manufacture foldable cardboard sheets, to form boxes one has to cut them according to predefined lines, e.g. by machines as described in EP2454083.

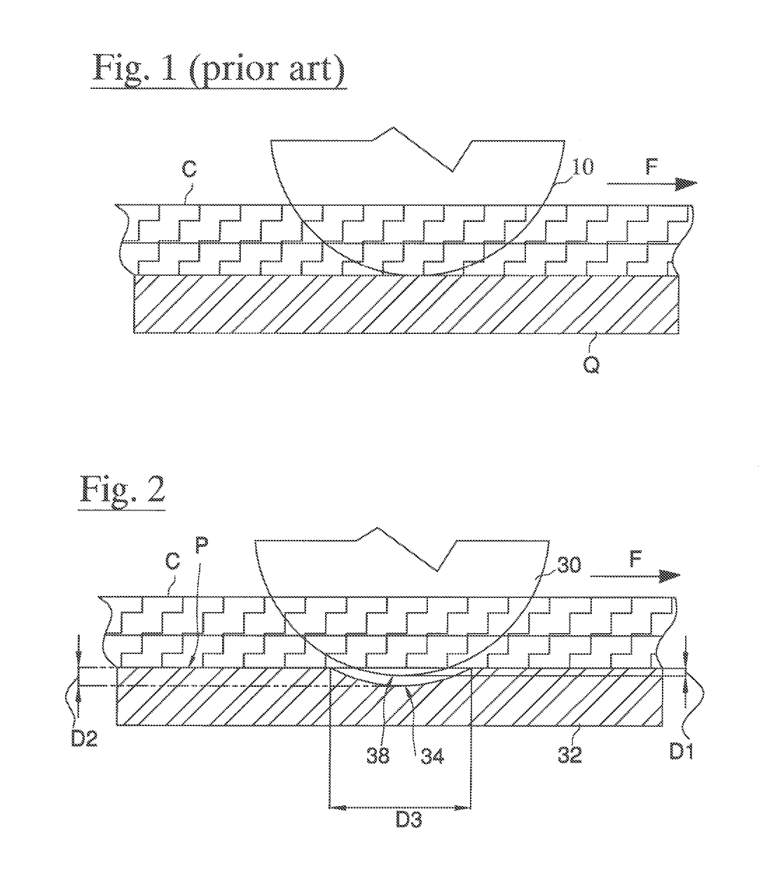

A common cutting system provides (FIG. 1) a rotating circular blade 10 which cuts a sheet of advancing cardboard C (direction F) over a rigid or flexible working plane Q or over a roller. Since the blade 10 is cutting and completely goes through the thickness of the cardboard C, there is the big disadvantage of damaging the working plane Q, or the underlying rollers, by the blade 10. Therefore the working plane Q or the roller must be replaced constantly and often.

To avoid rapid wear on other systems blades are used having reciprocating motion mounted on spindles equipable along two axes; in this case the cutting speed, and accordingly the hourly productivity, is low.

The main object of the invention is to provide an improved cutting device, which eliminates or reduces the defects mentioned above while maintaining or improving the quality of the cut.

The device for cutting a sheet or layer of material advancing on a working plane, comprises:

a working plane on which to advance the material,

a blade adapted to cut the material moved on the working plane,

wherein the blade comprises a cutting edge which is suspended within a cavity formed in the working plane, so that the cutting edge can come out from the material in correspondence of the cavity.

Since in this way the blade does not touch the working plane, all the related above-mentioned damages are avoided. In addition, the edge of the blade consumes a lot less, since it remains suspended inside the cavity.

Preferably the cavity is obtained as a concavity formed in the working plane. As an alternative, it is possible that the cavity may be a pass-through opening in/of the working plane, e.g. if the blade (see below) has too stringent excursions and/or manufacturing tolerances.

Preferably the blade is circular, but not necessarily.

Experimentally it has been noted that the breaking of the material by a free-wheeling blade sometimes produces, on the side of the material facing the working plane, some chipped edges or cutting imperfections. To resolve this problem it is preferable that the blade is connected to an electric motor to be set in rotation. The forced movement of the blade has the advantage of producing a cut being precise and unconditioned by the feeding of the material.

To transfer motion from the electric motor to the blade various systems are possible.

The preferred ones are those which allow to reduce the size of the mechanical group that supports the blade, so as to limit to a minimum the freedom of placement of the blade on the work plane.

A preferred solution that ensures compactness is that the blade is comprised in the rotor of an electric motor, (e.g. a brushless and/or synchronous and/or asynchronous rnotor) or that the blade comprises a circular toothing engaged with a pinion connected to the electric motor. Or the device comprises a pulley keyed to the blade and, by belt transmission, the blade is operated to rotate.

As preferred variants, the device according to the invention comprises:
a pinion integral with the blade, and
a transmission system for transmitting rotary motion from a shaft driven by the electric motor to the pinion.

The transmission system may comprise in particular:
a belt or chain engaged around the pinion and engaged around the shaft, and/or
a toothed wheel or a gear train or gear wheels, one of which is keyed on the shaft and one keyed on, or in place of, the pinion.

Said shaft may also comprise a smooth cylindrical surface, and the transmission system may comprise a train of smooth wheels or clutches, one of which is keyed on—or in substitution of—the pinion and one mounted in contact with the smooth cylindrical surface for receiving rotary motion.

The blade may also be comprised directly in or be part of a rotor of an electric motor. For this aim, a preferred construction is that the blade is integrally connected to the rotor of a motor whose stator is mounted in a movable support to move the blade closer to or away from the working plane.

In all variants the blade is preferably movable with respect to the working plane. For this purpose the device preferably comprises an element on which the blade is rotatably mounted, the element being movable in a direction orthogonal to the working plane so as to move the blade into a lowered working position towards the working plane or a resting position wherein the blade is raised or moved away from the working plane.

Another solution to the problem of the above-mentioned cutting imperfections is obtained by providing the device with a vibrator drive, adapted to vibrate the blade. The vibrator drive can induce vibrations on the blade e.g. by means of ultrasound and/or an electromagnet (that is, a variable magnetic field is exploited acting on a metal blade) and/or via a motorized system comprising kinematics of the connecting rod-crank type or camshaft type. In particular maximum effectiveness is achieved if the vibrator drive is configured to vibrate the blade alternately along its cutting plane and perpendicularly to the working plane.

The vibrator drive for example is arranged between two mounting shoulders for the blade and a vertical-movement actuator for the blade.

Another aspect of the invention is a cutting method for cutting a sheet or layer of material advancing on a working plane by means of a blade, wherein the blade is suspended within a cavity formed in the working plane, so that the cutting edge of the blade can come out from the material and pierce it in correspondence of the cavity.

All the variants listed for the device are equally usable as steps in the method, and with the same advantages, In particular, some preferred steps are:

suspending the blade inside a concavity formed in the working plane; and/or

suspending the blade inside a pass-through opening in/of the working plane; and

setting the blade into rotation via an operator drive; and/or

inducing vibrations on the blade, e.g. by means of ultrasound and/or a variable magnetic field and/or through a motorized system. In particular the blade is vibrated alternately along its cutting plane and perpendicular to the working plane.

The advantages of the invention will be more apparent from the following description of a preferred embodiment, with reference to the attached drawings wherein:

FIG. 1 shows a known cutting system,

FIG. 2 shows a basic diagram of a cutting system according the invention;

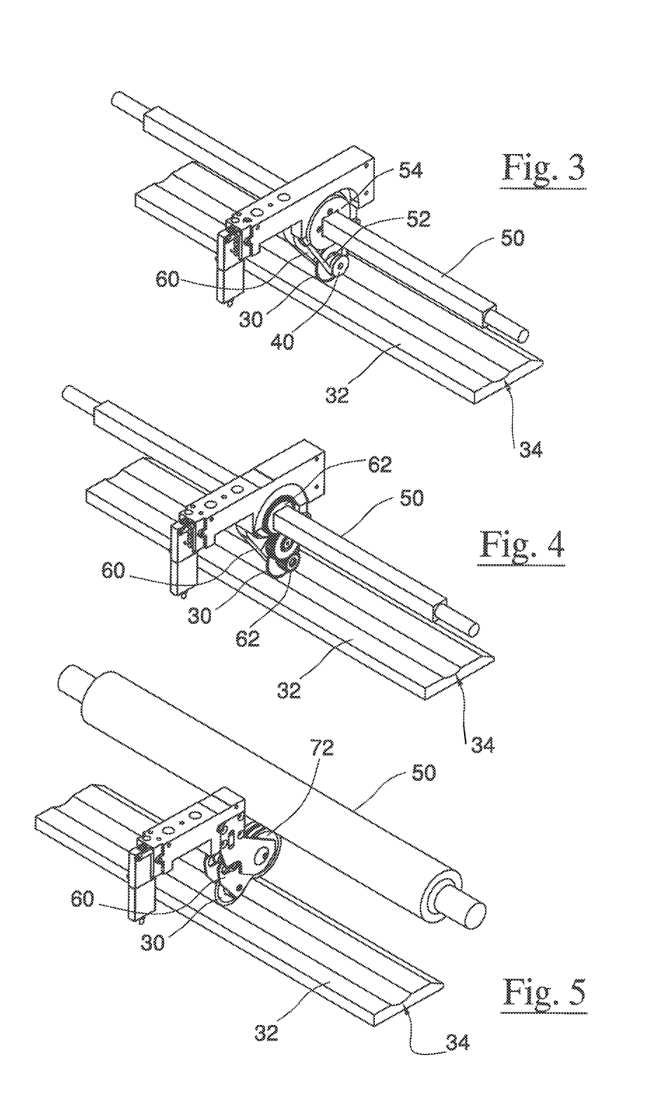

FIGS. 3-6 show variants for a cutting system according to the invention.

In the figures identical numbers indicate identical or similar parts.

The cutting system envisages a rotating circular blade 30 adapted to cut a sheet of cardboard C advancing (direction F) over a hard working plane 32. Under the blade 30, the plane 32 has a cavity or depression 34, preferably of circular cross-section, receding in negative compared to a flat portion P on which the cardboard C slides. The distance between the lying position of the plane P and the bottom of the cavity 34 has a maximum of value D2.

The cutting edge of the blade 30 is kept suspended inside the cavity or depression 34, so that part of its lower edge 38 is located at a maximum distance D1 from the level of the plane P.

Note that the condition D1<D2 ensures no contact between the edge 38 and the surrounding fixed parts.

D1 may e.g. be 1 mm. D2 may be e.g. 1.5 mm,

### OPERATION

By constructional geometry, when the cardboard C meets the blade 30 is cut from side to side and pierced through completely, so much that a part of the blade 30, the edge 38, protrudes from the cut cardboard C by a portion approximately D3 long towards and within the cavity 34.

Variants

The cavity or depression 34 may be advantageously (simple solution) a concave zone in correspondence of which the working plane 32 has a recess with respect to the surrounding plane P contacting the sheet or layer of material C. The concave zone may have shape the e.g. of a spherical cap or a linear slot or have cylindrical cross-section.

The bottom of the cavity or depression 34 may be parallel to the plane P or curved, to reproduce an offset complementary profile of the edge 38 of the blade 30. In particular, the cross-section of the cavity 34 may have a radius of curvature approximately equal to that of the cutting edge of the blade 30.

It is possible, however, to also use a slot or a pass-through opening with respect to the plane 32.

The blade 30 may be
mounted idle or rotating through an operator drive and/or vibrating; and/or
not necessarily circular, i.e. a linear blade, preferably moved alternately, or a tip.

To prevent jamming or bending of the cardboard C below the blade 30, and too much advancing drag for the cardboard C, it is preferable to maintain the cavity 34 of contained size.

One embodiment is illustrated in FIG. 3, wherein a blade 30 is set into rotation through a pinion 40 which is integral with the blade 30 itself, preferably in a coaxial manner. The pinion. 40 (or the rotation axis of the blade) is e.g. connected to a support 60, e.g. in the form of one or two movable shoulders or an oscillating element (preferably a fork on which the blade is rotatably engaged). The support 60 is movable in the direction orthogonal to the working plane 32, by means of an actuator, so as to move the blade 30 to a working position (lowered toward the working plane 32) or a resting position (raised or moved away from the working plane 32).

The pinion 40 is preferably connected to a motor or an actuating means, so as to receive rotary motion and transfer it to the blade 30 to make it rotate. Preferably the rotary motion is taken from a shaft 50 coaxial to the pinion 40 and the blade 30, the shaft 50 thereby allowing to operate also several blades 30 placed parallel to each other on side-by-side supports 60.

The transmission system for transmitting rotary motion from the shaft 50 (or from an output shaft of a generic electric motor) to the blade 30 and/or to the pinion 40 may vary.

Such transmission system may comprise e.g.:
a belt or chain 52 (FIG. 3) which engages around the pinion (or spool) 40 and around a disk 54 keyed on the shaft 50 or around the shaft 50 itself; and/or
a toothed wheel 62 or a train of gears or sprockets 62 (FIG. 4), of which one is keyed on the shaft 50 and one is keyed on (or in substitution for) the pinion 40; and/or
a train of smooth wheels or clutches 72 (FIG. 5), one of which is keyed on the shaft 50 and one is keyed on (or in substitution for) the pinion 40. In this variant, the shaft 50 may also be a smooth shaft and a smooth wheel or friction may be simply mounted in contact with the smooth shaft to receive rotary motion. The use of friction wheels or smooth wheels has the advantage that the possible rotation blockage of a single blade does not influence the others, and that the meshing of the same wheels, in the case of single motor embodiment, is not influenced by the mutual position of the teeth.

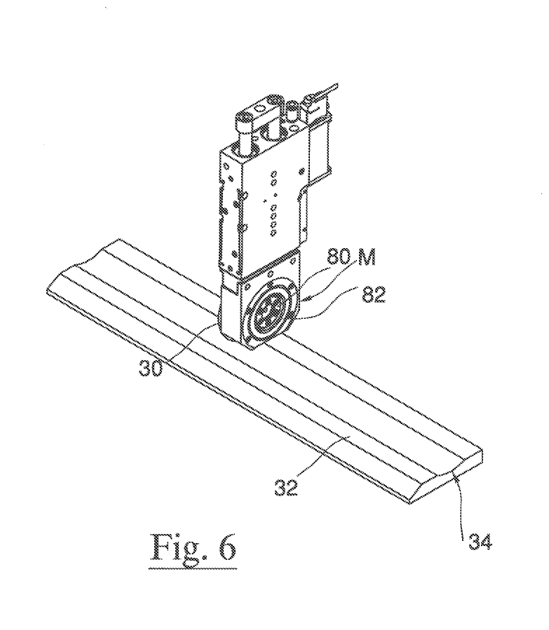

Another preferred solution, which ensures compactness, is that the blade 30 is comprised in the rotor of an electric motor (e.g. a brushless and/or synchronous or asynchronous motor). See the example of FIG. 6. The blade 30 is integrally connected with the rotor 80 of a motor M whose stator 82 is preferably connected with a movable support like the said vertically movable support 60. The advantage of this variant resides in the elimination of mechanical links or transmission shafts, thereby making the system much more compact and flexible for various types of cutting.

The motion of the blade 30 needs not necessarily be rotational. Another variant provides that such motion is generated by a sonotrode applied to the blade. In particular the sonotrode may be applied between two shoulders for mounting the blade and a vertical-movement actuator, or between said support 60 and its actuator. The cutting energy in this case is supplied by high-frequency vibrations generated by the sonotrode (ultrasound.).

1. Device for cutting a sheet or layer of material advancing on a working plane, comprising:
a working plane on which to advance the material,
a blade adapted to cut the material moved on the working plane,
the blade comprising a cutting edge which is suspended within a cavity formed in the working plane, so that the cutting edge can come out from the material in correspondence of the cavity.

2. Device according to claim 1, wherein the cavity is a concavity formed in the working plane.

3. Device according to claim 1, wherein the cavity is a pass-through opening of the working plane.

4. Device according to claim 1, wherein the blade is circular.

5. Device according to claim 1, wherein the blade is connected to an electric motor to be set in rotation.

6. Device according to claim 5, wherein the blade is comprised in the rotor of the electric motor.

7. Device according to claim 5, wherein the blade comprises a circular toothing engaged with a pinion connected to the electric motor.

8. Device according to claim 5, comprising
a pinion integral with the blade, and
a transmission system to transmit rotary motion from a shaft operated by the electric motor to the pinion

9. Device according to claim 8, wherein the transmission system comprises a belt or a chain engaged around the pinion and around the shaft.

10. Device according to claim 8, wherein the transmission system comprises a toothed wheel or a train gear o toothed gears, one of which is keyed on the shaft and one is keyed on, or in substitution of, the pinion.

11. Device according to claim 8, wherein
the shaft comprises a smooth cylindrical surface, and
the transmission system comprises a train of smooth wheels or clutches, one of which is keyed on—or in substitution of—the pinion and one is mounted in contact with the smooth cylindrical surface to receive rotary motion.

12. Device according to claim 1, wherein the blade is comprised in the rotor of an electric motor.

13. Device according to claim 12, wherein the blade is integrally connected to the rotor of a motor (M) whose stator is mounted movable to move the blade close to or away from the working plane.

14. Device according to claim 1, comprising an element on which the blade is rotatably mounted, the element being movable in direction orthogonal to the working plane so as to move the blade toward a lowered working position toward the working plane or a resting position raised or moved away from the working plane.

15. Device according to claim 1, comprising a vibrator drive adapted to vibrate the blade, e.g. by ultrasound.

16. Device according to claim 15, wherein the vibrator drive is configured to vibrate the blade alternately along its cutting plane and perpendicular to the working plane.

17. Device according to claim 15, wherein the vibrator drive is applied between two mounting shoulders for the blade and a vertical motion actuator for the blade.
